(19) United States
(12) Patent Application Publication
(10) Pub. No.: US 2010/0285293 A1
(43) Pub. Date: Nov. 11, 2010

(54) MULTIFUNCTIONAL ADHESIVE FILM, PLASMA DISPLAY PANEL FILTER CONTAINING THE SAME AND PLASMA DISPLAY PANEL CONTAINING THE SAME

(76) Inventors: Su-Rim Lee, Daejeon Metropolitan City (KR); Sang-Hyun Park, Daejeon Metropolitan City (KR); Jung-Doo Kim, Daejeon Metropolitan City (KR)

Correspondence Address: MCKENNA LONG & ALDRIDGE LLP, 1900 K STREET, NW, WASHINGTON, DC, 20006, US

(21) Appl. No.: 12/811,977

(22) PCT Filed: Jan. 8, 2009
(86) PCT No.: PCT/KR09/00109

§ 371 Date: Jul. 7, 2010

(30) Foreign Application Priority Data
Jan. 8, 2008 (KR) 10-2008-0002207

(51) Int. Cl. F21V 9/04; B32B 9/00

(52) U.S. Cl. 428/220; 252/587; 428/355 R

(57) ABSTRACT

The present invention relates to a multifunctional adhesive film that has at least one of a near IR absorption dye and/a color correction dye and a UV stabilizer, a plasma display panel filter including the same and a plasma display panel including the same.

Since the multifunctional adhesive film does not require a layer that has a separate UV blocking function, it is possible to manufacture a thin type optical filter, and it is possible to improve the productivity and lower a cost by simplifying a process by an epoch-making structure simplification.

### TECHNICAL FIELD

The present invention relates to a multifunctional adhesive film that has a near IR absorption function and/or a color correction function and UV blocking function, a plasma display panel filter including the same and a plasma display panel including the same.

This application claims priority from Korean Patent Application No. 2008-0002207 filed on Jan. 8, 2008 in the KIPO, the disclosure of which is incorporated herein by reference in its entirety.

### BACKGROUND ART

In general, a display device is a common name of TVs or monitors for computer, and includes a display module that has a display panel for forming an image and a casing that supports the display module.

The display module includes a display panel such as CRT (Cathode Ray Tube), LCD (Liquid Crystal Display) and plasma display panel, a driving circuit substrate for driving the display panel, and an optical filter that is disposed in front of the display panel.

The plasma display panel filter compensates a reduction in red spectrum purity by a special orange spectrum that is emitted from the panel, and shelters near IR that causes misoperation of remote controller and electromagnetic wave that is harmful to human. In order to act like this, the plasma display panel filter includes an antireflection layer, a color correction layer that corrects the color purity, a near IR absorption layer, electromagnetic wave sheltering layer that each have the function. The layers that have the functions, in general, are formed of a film, and a method for layering the layers by using a separate adhesive agent is mainly used.

Meanwhile, if a single film has all functions such as color correction and near IR absorption or the structure thereof is simplified by lowering the number of used films, it is possible to minimize defects that are generated in the layering process and save material. For example, the number of layers that are used in the plasma display panel filter can be reduced by half by forming the layers having different functions on both sides of the film such that the single film has a plurality of functions. In addition, the structure can be simplified by layering the film.

For example, in order to block near IR and perform color correction, the material that absorbs them is required, and a dye is mainly used for this. As the dye, there are a neon-cut dye and near IR absorption dye that absorb a specific. As a general method for applying dyes, there is a method for coating a dye that is mixed with a binder polymer on a transparentization substrate. The method should layer a substrate on a predetermined layer in the plasma display panel filter by using an adhesive agent. In addition, many studies have been made to simultaneously provide a color correction function and near IR absorption function to an adhesive agent layer that is required in layering of the films that have different functional properties in order to lower a manufacturing cost or simplify a process for the plasma display panel filter.

### DISCLOSURE

### Technical Problem

However, since an adhesive agent layer that has a color correction and/or near IR absorption function does not have a UV stabilizing function, when it is exposed to UV, the near IR absorption dye and color correction dye are discolored, such that performance as an optical film may be lowered.

Accordingly, until now, by adding a UV blocking film (TAC or UV PET) in front of the adhesive agent layer that has the near IR absorption and/or color correction function, the film is protected from UV, but since the UV film is expensive and should be disposed in front of the functional film, the degree of freedom thereof is low in terms of structure.

### Technical Solution

Therefore, it is an object of the present invention to provide a multifunctional adhesive film in which a UV stabilizing function is provided to the adhesive film by adding a UV stabilizer that is suitable to an adhesive film that has a near IR absorption and/or color correction function, a plasma display panel filter including the same and a plasma display panel including the same.

### ADVANTAGEOUS EFFECTS

Since the multifunctional adhesive film according to the present invention does not require a layer that has a separate UV blocking function, it is possible to manufacture a thin type optical filter, and it is possible to improve the productivity and lower a cost by simplifying a process by an epoch-making structure simplification.

### DESCRIPTION OF DRAWINGS

FIGS. 1 to 19 are graphs that illustrate measurement of durability of the multifunctional adhesive films that are manufactured in Example 1 to Example 9 and Comparative Examples 1 to 8 according to the present invention.

### BEST MODE

The present invention provides a multifunctional adhesive film that includes at least one of near IR absorption dye and color correction dye and a UV stabilizer. In detail, the multifunctional adhesive film according to the present invention may include a color correction dye and UV stabilizer, a near IR absorption dye and UV stabilizer, or a near IR absorption dye, color correction dye and UV stabilizer.

In the multifunctional adhesive film, as a component that provides an adhesive property, any one may be used without a limitation as long as it does not limit permeation of light as a pressure reduction adhesive agent (Pressure Sensitive Adhesive) component.

The adhesive agent that is used in the present invention is not particularly limited as long as it is used in a general adhesive sheet, adhesive film and the like. For example, there are acryls, urethanes, polyisobutylenes, SBR (styrene-butadiene rubber), rubbers, polyvinylethers, epoxys, melamines, polyesters, phenols, silicons and a copolymer thereof, and in particular, the acryl-based adhesive agent is preferable.

It is preferable that the glass transition temperature (Tg) of the acryl-based adhesive agent is 0° C. or less. The acryl-based adhesive agent is manufactured by copolymerizing 75 to 99.89 wt % of (metha)acrylate ester monomer having an alkyl group having 1 to 12 carbon atoms, 0.1 to 20 wt % of α, β unsaturated carboxylic acid monomer that is a functional monomer and 0.01 to 5 wt % of a polymerizable monomer having a hydroxyl group. Since the copolymerization method is well known to those who are skilled in the art, a detailed condition thereof will be omitted.

As the acryl-based adhesive agent, more preferably, when butyl acrylate (BA)/hydroxy ethyl methacrylate (HEMA) copolymer, or butyl acrylate/acrylic acid (AA) copolymer is used, as compared to the other acryl-based adhesive agent, the absorption function is excellent in the near IR region and the near IR absorption dye is stabilized.

When the multifunctional adhesive film is manufactured, a solvent may be further used, and as the solvent, a general organic solvent may be used, and preferably methylethylketone (MEK), tetrahydrofurane (THF), ethyl acetate or toluene may be used. In addition, the content of the solvent is not particularly limited. However, it is preferable that a residual solvent amount in the film after the multifunctional adhesive film is manufactured is 5 wt % or less. In the case of when the residual solvent amount is more than 5 parts by weight, discoloration may occur because of the dye and UV stabilizer, and the level of adhesive force may not approach the desired degree.

The multifunctional adhesive film according to the present invention may further include a crosslinking agent and coupling agent.

The crosslinking agent is a multifunctional compound, and may include an isocyanate-based crosslinking agent, epoxy-based crosslinking agent, azilidine-based crosslinking agent or metal chelate-based crosslinking agent. More preferably, the isocyanate-based crosslinking agent is used, and examples thereof include tolylene diisocyanate, xylene diisocyanate, diphenylmethane diisocyanate or hexamethylene diisocyanate, but are not limited thereto. The content of the crosslinking agent may be used by 0.01 to 2 parts by weight on the basis of 100 parts by weight of the adhesive agent component.

It is preferable that the coupling agent is a silane-based coupling agent. In the case of when the silane-based coupling agent is left for a long time at high temperature and high humidity, it helps to improve attachment reliability. Vinyl silane, epoxy silane, methacryl silane and the like may be used as the silane-based coupling agent. For example, there are vinyltrimetoxy silane, vinyltrietoxy silane, γ-glycycloxypropyltrimetoxy silane, or γ-methacryloxypropyltrimetoxy silane and the like, and these may be used alone or may be used while they are mixed with each other. The content of the silane-based coupling agent may be used by 0.01 to 2 parts by weight on the basis of 100 parts by weight of the adhesive agent component.

The multifunctional adhesive film according to the present invention may use additives such as an antioxidizing agent such as phenols, phosphoruses, a flame retardant such as halogens, phosphates or anti-static agent such as alkylene oxides. The content of the additive may be used by 0.01 to 10 parts by weight on the basis of 100 parts by weight of the adhesive agent component.

The near IR absorption dye is one or more dyes that are selected from the group consisting of a metal complex-based dye, phthalocyanine-based dye, naphthalocyanine-based dye, cyanine-based dye having an intermolecular metal-complex shape and diimonium-based dye. Among them, if the metal complex-based and/or phthalocyanine-based dye is used, it is possible to provide excellent durability and near IR absorption performance in the adhesive agent, which is the most preferable.

In addition, in the case of when the metal complex-based dye and phthalocyanine-based dye are mixed and used, as compared to the case of when each of them is used alone, the durability may be improved and the visible ray region penetration ratio may be more improved, which is more preferable.

In the case of when only the metal complex-based dye is used, the visible ray region penetration ratio, but as compared to the case of when it is mixed with the phthalocyanine-based dye, the durability is relatively low. In the case of when only the phthalocyanine-based dye is used, as compared to the case of when the metal complex-based dye and the phthalocyanine-based dye are used while being mixed and only the metal complex-based dye is used, the visible ray region penetration ratio is relatively low.

As the metal complex-based dye, the compound that is represented by the following Formula 1 or Formula 2 may be used.

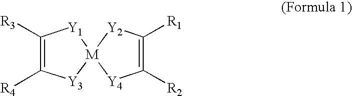

R₁ to R₄ are the same as or different from each other, and independently, a hydrogen atom; halogen atom; nitro group; cyano group; hydroxy group; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; a C_{6˜20} aryloxy group where a halogen atom, cyano group, or nitro group is substituted or unsubstituted; a C_{1˜16} alkyl amino group where a halogen atom, cyano group, or nitro group is substituted or unsubstituted; a C_{6˜20} aryl amino group where a halogen atom, cyano group, or nitro group is substituted or unsubstituted; a C_{1˜16} alkyl thio group where a halogen atom, cyano group, or nitro group is substituted or unsubstituted; or a C_{6˜20} aryl thio group where a halogen atom, cyano group, or nitro group is substituted or unsubstituted,

Y₁ to Y₄ are independently S or O,

M is any one that is selected from the group consisting of metal atoms of Ni, Cu, Pt and Pd.

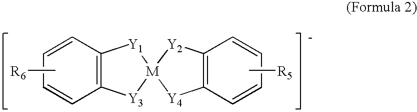

wherein

R₅ and R₆ are the same as or different from each other, and independently, a hydrogen atom; halogen atom; nitro group; cyano group; hydroxy group; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; a C_{6˜20} aryloxy group where a halogen atom, cyano group, or nitro group is substituted or unsubstituted; a C_{1˜16} alkyl amino group where a halogen atom, cyano group, or nitro group is substituted or unsubstituted; a C_{6˜20} aryl amino group where a halogen atom, cyano group, or nitro group is substituted or unsubstituted; a C_{1˜16} alkyl thio group where a halogen atom, cyano group, or nitro group is substituted or unsubstituted; or a C_{6˜20} aryl thio group where a halogen atom, cyano group, or nitro group is substituted or unsubstituted,

Y₁ to Y₄ are independently S or O,

M is any one that is selected from the group consisting of metal atoms of Ni, Cu, Pt and Pd.

In Formula 1 and Formula 2, R₁ to R₆ is the same as or different from each other, and a C_{6˜20} aryl group where a halogen atom is substituted or unsubstituted; a C_{6˜20} aryloxy group wherein a halogen atom is substituted or unsubstituted; a C_{1˜16} alkyl thio group where a halogen atom is substituted or unsubstituted; or a C_{6˜20} aryl thio group where a halogen atom is substituted or unsubstituted, Y₁ to Y₄ are S, and M is a metal atom of Ni.

The metal complex-based dye ensures excellent durability in the adhesive agent and the maximum absorption in the near IR region, and small light absorption in the visible ray region. In general, the other kind of near IR absorption dye has the lowered durability in the adhesive agent but the metal complex-based dye may provide excellent durability in the adhesive agent.

Since the glass transition temperature (Tg) of the generally used adhesive agent is −40° C., polymer segments that are main components of the adhesive agent move little by little at normal temperature and high temperature and high humidity, but since dyes may move in the binder that is not fixed, aggregation may occur, and the molecular is broken, such that original function may not performed any more. However, in the case of the metal complex-based dye, since it is possible to maintain the stable molecular structure in the adhesive agent, it is possible to maintain the original function at the high temperature and high humidity condition.

In a state in which the near IR region absorption degrees of the metal complex-based dye and the phthalocyanine-based dye are the same as each other, if the visible ray region penetration ratios of two dyes are compared to each other, the visible ray region penetration ratio of the phthalocyanine-based dye is low, and the visible ray region penetration ratio of the metal complex-based dye is high, such that in the case of when only the metal complex-based dye is used, the visible ray region penetration ratio is increased.

As the phthalocyanine-based dye, the compound that is represented by Formula 3 may be used.

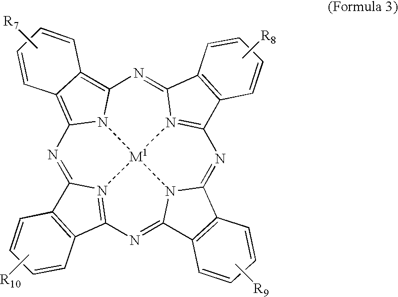

wherein

R₇ to R₁₀ are the same as or different from each other, and independently, a hydrogen atom; halogen atom; trifluoro methyl group; nitro group; cyano group; hydroxy group; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{2˜26} alkoxy group where a halogen atom, cyano group, or nitro group is substituted or unsubstituted; a C_{6˜20} aryloxy group where a halogen atom, cyano group, or nitro group is substituted or unsubstituted; a C_{2˜26} alkyl amino group where a halogen atom, cyano group, or nitro group is substituted or unsubstituted; a C_{6˜20} aryl amino group where a halogen atom, cyano group, or nitro group is substituted or unsubstituted; a C_{2˜26} alkyl thio group where a halogen atom, cyano group, or nitro group is substituted or unsubstituted; or a C_{6˜20} aryl thio group where a halogen atom, cyano group, or nitro group is substituted or unsubstituted,

M′ is selected from a divalent metal atom that consists of Cu, Zn, Fe, Co, Ni, ruthenium (Ru), rubidium (Rb), palladium (Pd), Pt, Mn, Sn, Mg and Ti; trivalent 1-substituted metal atom that consists of Al—Cl, Ga—Cl, In—Cl, Fe—Cl and Ru—Cl; tetravalent 2-substituted metal atom that consists of SiCl₂, GaCl₂, TiCl₂, SnCl₂, Si(OH)₂, Ge(OH)₂. Mn(OH)₂ and Sn(OH)₂; and an oxy metal atom that consists of VO, MnO and TiO.

The phthalocyanine-based dye ensures excellent durability in the adhesive agent and the maximum absorption in the near IR region, and absorbs light in the visible ray region. In general, the other kind of near IR absorption dye has the lowered durability in the adhesive agent but the metal complex-based dye may provide excellent durability in the adhesive agent.

Since the glass transition temperature (Tg) of the generally used adhesive agent is −40° C., polymer segments that are main components of the adhesive agent move little by little at normal temperature and high temperature and high humidity, but since dyes may move in the binder that is not fixed, aggregation may occur, and the molecular is broken, such that original function may not performed any more. However, in the case of the phthalocyanine-based dye, since it is possible to maintain the stable molecular structure in the adhesive agent, it is possible to maintain the original function at the high temperature and high humidity condition.

As the naphthalocyanine-based dye, the compound that is represented by Formula 4 may be used.

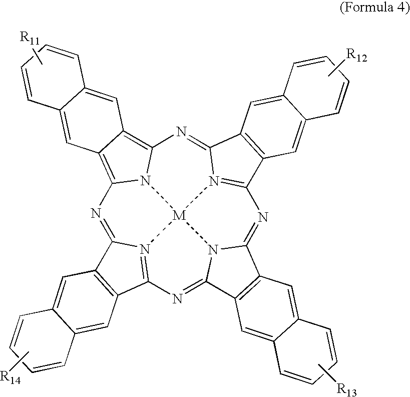

wherein

R₁₁ to R₁₄ are the same as or different from each other, and independently, a hydrogen atom; halogen atom; trifluoro methyl group; nitro group; cyano group; hydroxy group; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; a C_{6˜20} aryloxy group where a halogen atom, cyano group, or nitro group is substituted or unsubstituted; a C_{1˜16} alkyl amino group where a halogen atom, cyano group, or nitro group is substituted or unsubstituted; a C_{6˜20} aryl amino group where a halogen atom, cyano group, or nitro group is substituted or unsubstituted; a C_{1˜16} alkyl thio group where a halogen atom, cyano group, or nitro group is substituted or unsubstituted; or a C_{6˜20} aryl thio group where a halogen atom, cyano group, or nitro group is substituted or unsubstituted,

M′ is selected from a divalent metal atom that consists of Cu, Zn, Fe, Co, Ni, ruthenium (Ru), rubidium (Rb), palladium (Pd), Pt, Mn, Sn, Mg and Ti; trivalent 1-substituted metal atom that consists of Al—Cl, Ga—Cl, In—Cl, Fe—Cl and Ru—Cl; tetravalent 2-substituted metal atom that consists of SiCl₂, GaCl₂, TiCl₂, SnCl₂, Si(OH)₂, Ge(OH)₂, Mn(OH)₂ and Sn(OH)₂; and an oxy metal atom that consists of VO, MnO and TiO.

As the cyanine-based dye that has the intermolecular metal-complex shape, the compounds that are represented by Formula 5, Formula 6 and Formula 7 may be used.

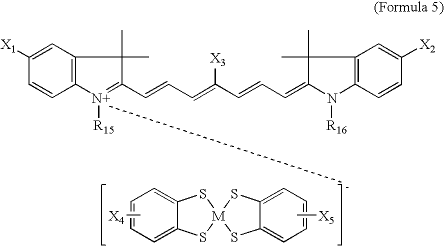

wherein

R₁₅ and R₁₆ are the same as or different from each other, and independently, a hydrogen atom; a C_{1˜30} straight- or branched-chained alkyl group where a halogen atom, cyano group, or nitro group is substituted or unsubstituted; a C_{1˜8} alkoxy group where a halogen atom, cyano group, or nitro group is substituted or unsubstituted; or a C_{6˜30} aryl group where a halogen atom, cyano group, or nitro group is substituted or unsubstituted,

X₁ to X₅ are the same as or different from each other, and independently, a halogen group; nitro group; carboxyl group; phenoxycarbonyl group; carboxylate group; a C_{1˜8} alkyl group where a halogen atom, cyano group, or nitro group is substituted or unsubstituted; a C_{1˜8} alkoxy group where a halogen atom, cyano group, or nitro group is substituted or unsubstituted; or a C_{6˜30} aryl group where a halogen atom, cyano group, or nitro group is substituted or unsubstituted,

M is any one that is selected from the group consisting of metal atoms of Ni, Cu, Pt and Pd.

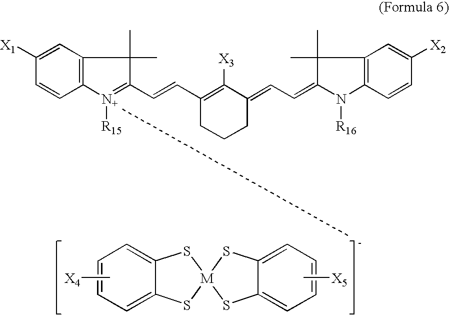

wherein

R₁₅, R₁₆, X₁ to X₅ and M are the same as those defined in Formula 5.

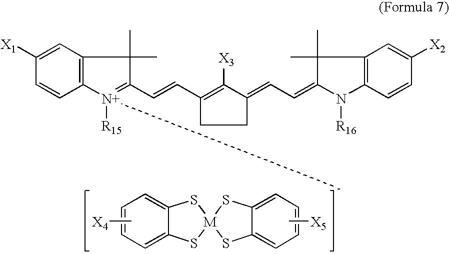

wherein

R₁₅, R₁₆, X₁ to X₅ and M are the same as those defined in Formula 5.

As the diimonium-based dye, the compound that is represented by Formula 8 may be used.

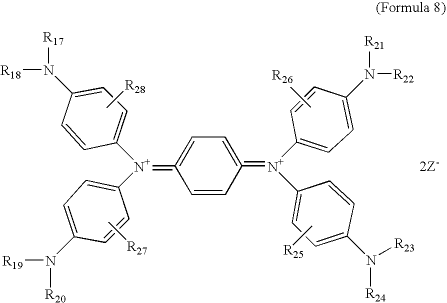

wherein

R₁₇ to R₂₄ are the same as or different from each other, and independently, a hydrogen atom; halogen atom; trifluoro methyl group; nitro group; cyano group; hydroxy group; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; a C_{6˜20} aryloxy group where a halogen atom, cyano group, or nitro group is substituted or unsubstituted; a C_{1˜16} alkyl amino group where a halogen atom, cyano group, or nitro group is substituted or unsubstituted; a C_{6˜20} aryl amino group where a halogen atom, cyano group, or nitro group is substituted or unsubstituted; a C_{1˜16} [symbol] alkyl thio group where a halogen atom, cyano group, or nitro group is substituted or unsubstituted; or a C_{6˜20} aryl thio group where a halogen atom, cyano group, or nitro group is substituted or unsubstituted,

R₂₅ to R₂₈ are independently, a hydrogen atom; halogen atom; cyano group; nitro group; carboxyl group; an alkyl group where a halogen atom, cyano group, or nitro group is substituted or unsubstituted; or an alkoxy group where a halogen atom, cyano group, or nitro group is substituted or unsubstituted,

Z is an organic acid monovalent anion, organic acid divalent anion or inorganic acid monovalent anion.

As the organic acid monovalent anion, an organic carboxylic acid ion, for example, an acetate ion, lactate ion, trifluoroacetate ion, propionate ion, benzoate ion, oxalate ion, succinate ion and stearate ion; an organic sulfonic acid ion, for example, a methane sulfonate ion, toluene sulfonate ion, naphthalene mono sulfonate ion, chlorobenzene sulfonate ion, nitrobenzene sulfonate ion, dodecylbenzene sulfonate ion, benzene sulfonate ion, ethane sulfonate ion and trifluoromethane sulfonate ion; and an organic boronic acid ion, for example, a tetraphenylborate ion and butyltriphenylborate ion are preferable.

As the organic acid divalent anion, a naphthalene-1,5-disulfonic acid, naphthalene-1,6-disulfonic acid, naphthalene disulfonic acid derivative and the like may be used.

As the inorganic acid monovalent anion, a halogenite ion, for example, a fluoride ion, chloride ion, bromide ion, iodide ion, thiocyanate ion, hexafluoroantimonoate ion, perchlorate ion, periodate ion, nitrate ion, tetrafluoroborate ion, hexafluorophosphate ion, molybdate ion, tungstate ion, titanate ion, vanadate ion, phosphate ion or borate ion or the like may be used.

The content of the near IR absorption dye may be used by 0.01 to 10 parts by weight on the basis of 100 parts by weight of the multifunctional adhesive film.

If the content of the near IR absorption dye is less than 0.01 parts by weight, the near IR absorption efficiency is lowered to cause the remote controller, such that the dye as the product may not work, and if the content is more than 10 parts by weight, the penetration ratio is largely lowered, such that a desired optical property is not obtained and a cost is increased.

In the multifunctional adhesive film according to the present invention, it is preferable that a neon-cut dye is used as the color correction dye. In addition, according to the specification of the product, various kinds of color correction dye in addition to the neon-cut dye may be further added.

As the neon-cut dye, one or more that are selected from the group consisting of a porphyrine-based color correction dye that has an intramolecular metal-complex shape, a cyanine-based color correction dye that has an intermolecular metal-complex shape, and a squarylium-based color correction dye that has an intermolecular metal-complex shape may be used. Among them, if the porphyrine-based color correction dye that has the intramolecular metal-complex shape is used, excellent durability can be ensured in the adhesive agent, which is most preferable.

Since the glass transition temperature (Tg) of the generally used adhesive agent is −40° C., polymer segments that are main components of the adhesive agent move little by little at normal temperature and high temperature and high humidity, but since dyes may move in the binder that is not fixed, aggregation may occur, and the molecular is broken, such that original function may not performed any more. However, in the case of the porphyrine-based color correction dye, since it is possible to maintain the stable molecular structure in the adhesive agent, it is possible to maintain the original function at the high temperature and high humidity condition.

As the porphyrine-based color correction dye that has the intramolecular metal-complex shape, the compound that is represented by the following Formula 9 may be used.

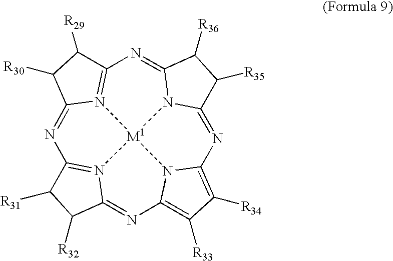

wherein

R₂₉ to R₃₆ are the same as or different from each other, and independently, a hydrogen atom; halogen atom; a C_{1˜16} alkyl group where a halogen atom, cyano group, or nitro group is substituted or unsubstituted; a C_{1˜16} alkoxy group where a halogen atom, cyano group, or nitro group is substituted or unsubstituted; a C_{1˜16} alkoxy group where a halogen atom, cyano group, or nitro group is substituted or unsubstituted and fluorine is substituted; a C_{2˜20} aryl group where a halogen atom, cyano group, or nitro group is substituted or unsubstituted, a C_{2˜20} aryloxy group where a halogen atom, cyano group, or nitro group is substituted or unsubstituted; or a pentagonal cycle where a halogen atom, cyano group, or nitro group is substituted or unsubstituted and one or more nitrogen atoms are included,

M″ is selected from a hydrogen atom, an oxygen atom, a halogen atom, a divalent metal atom that consists of Cu, Zn, Fe, Co, Ni, ruthenium (Ru), rubidium (Rb), palladium (Pd), Pt, Mn, Sn, Mg and Ti; trivalent 1-substituted metal atom that consists of Al—Cl, Ga—Cl, In—Cl, Fe—Cl and Ru—Cl; tetravalent 2-substituted metal atom that consists of SiCl₂, GaCl₂, TiCl₂, SnCl₂, Si(OH)₂, Ge(OH)₂, Mn(OH)₂ and Sn(OH)₂; and an oxy metal atom that consists of VO, MnO and TiO.

As the cyanine-based color correction dye that has the intermolecular metal-complex shape, the compound that is represented by the following Formula 10 may be used, and as the squarylium-based color correction dye that has the intermolecular metal-complex shape, the compound that is the following Formula 11 may be used.

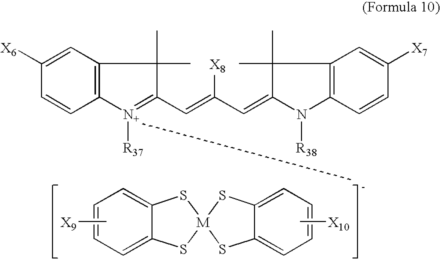

wherein

R₃₇ and R₃₈ are the same as or different from each other, and independently, a hydrogen atom; a C_{1˜30} straight- or branched-chained alkyl group where a halogen atom, cyano group, or nitro group is substituted or unsubstituted; a C_{1˜8} alkoxy group where a halogen atom, cyano group, or nitro group is substituted or unsubstituted; or a C_{6˜30} aryl group where a halogen atom, cyano group, or nitro group is substituted or unsubstituted,

X₆ to X₁₀ are the same as or different from each other and independently a hydrogen atom; halogen group; nitro group; carboxyl group; phenoxycarbonyl group; carboxylate group; a C_{1˜8} alkyl group where a halogen atom, cyano group, or nitro group is substituted or unsubstituted; a C_{1˜8} alkoxy group where a halogen atom, cyano group, or nitro group is substituted or unsubstituted; or C_{6˜30} aryl group,

M is any one that is selected from the group consisting of metal atoms of Ni, Cu, Pt and Pd.

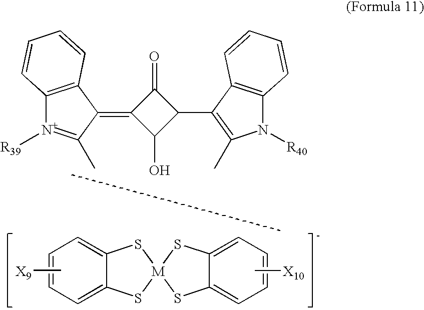

wherein

R₃₉ and R₄₀ are the same as or different from each other, and independently, a hydrogen atom; a C_{1˜30} straight- or branched-chained alkyl group where a halogen atom, cyano group, or nitro group is substituted or unsubstituted; a C_{1˜8} alkoxy group where a halogen atom, cyano group, or nitro group is substituted or unsubstituted; or a C_{6˜30} aryl group where a halogen atom, cyano group, or nitro group is substituted or unsubstituted,

X₉ and X₁₀ are the same as or different from each other and independently a hydrogen atom; halogen group; nitro group; carboxyl group; phenoxycarbonyl group; carboxylate group; a C_{1˜8} alkyl group where a halogen atom, cyano group, or nitro group is substituted or unsubstituted; a C_{1˜8} alkoxy group where a halogen atom, cyano group, or nitro group is substituted or unsubstituted; or C_{6˜30} aryl group,

M is any one that is selected from the group consisting of metal atoms of Ni, Cu, Pt and Pd.

The content of the color correction dye may be used by 0.005 to 10 parts by weight on the basis of 100 parts by weight of the multifunctional adhesive film.

If the content of the color correction dye is less than 0.005 parts by weight, the color correction dye efficiency may be lowered, and if the content is more than 10 parts by weight, the penetration ratio is lowered and a cost is increased.

The UV stabilizer may use one or more that are selected from the group consisting of the benzophonone-based absorption agent and benzotriazole-based absorption agent, and one or more radical scabenger compounds may be further used.

In the case of the radical scabenger, since it shows the UV absorption ability mainly at 300 nm or less, when it is used alone, its function as the UV stabilizer is slight, but when it is used in conjunction with the UV absorption agent, there is an increase effect.

The maximum absorption wavelength of the UV stabilizer is preferably 340 to 430 nm and more preferably 360 to 400 nm. In the case of when the maximum absorption wavelength of the UV stabilizer is less than 340 nm, the UV absorption ability may be lowered, and in the case of when the maximum absorption wavelength is more than 430 nm, it may affect the visible ray region penetration ratio and the color sense.

In addition, the penetration ratio of the multifunctional adhesive film according to the present invention in all wavelength regions of 380 nm or less is 35% or less, and after it is left in the UV-A light source at 60° C. for 100 hours, the penetration ratio is 35% or less in all wavelength region of 380 nm or less. In all wavelength regions of 380 nm or more, in the case of when the penetration ratio is more than 35%, the UV absorption ability is lowered, thus causing dye discoloration.

As the benzophonone-based absorption agent, the compound that is represented by the following Formula 12 may be used.

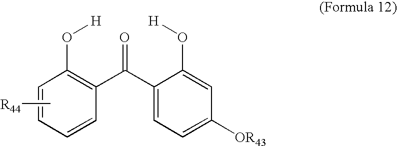

wherein

R₄₃ and R₄₄ are the same as or different from each other, and independently, a hydrogen atom; halogen atom; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; or a C_{6˜20} aryloxy group where a halogen atom, cyano group, or nitro group is substituted or unsubstituted.

In Formula 12, in the case of when only one hydroxy group exists at an ortho position in respects to a carbonyl group, the UV absorption ability is lowered, which is not suitable to UV stability.

As the benzotriazole)-based absorption agent, the compound that is represented by the following Formula 13 may be used.

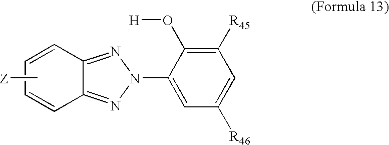

wherein

Z is a chlorine substituent,

R₄₅ and R₄₆ are the same as or different from each other, and independently, a hydrogen atom; halogen atom; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; or a C_{6˜20} aryloxy group where a halogen atom, cyano group, or nitro group is substituted or unsubstituted.

In the case of when Z is hydrogen, the UV stability is not excellent, which is not suitable.

As the radical scabenger (HALS) compound, the compound that is represented by the following Formula 14 may be used.

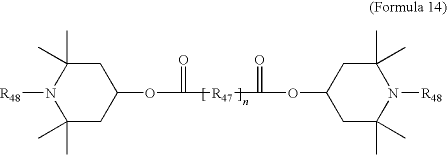

wherein

R₄₇ is CH₃,

n is in the range of 1 to 16,

R₄₈ is a hydrogen atom; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; a C_{6˜20} aryloxy group where a halogen atom, cyano group, or nitro group is substituted or unsubstituted.

In the case of the radical scabenger that is represented in Formula 14, since it shows the UV absorption ability mainly at 340 nm or less, when it is used alone, its function as the UV stabilizer is slight, but when it is used in conjunction with the UV absorption agent, there is an increase effect.

The content of the color correction dye may be used by 0.01 to 50 parts by weight on the basis of 100 parts by weight of the multifunctional adhesive film.

In detail, in the case of when the UV stabilizer is added in an amount of 0.01 to 50 parts by weight on the basis of 100 parts by weight of the multifunctional adhesive film, because of the stable UV absorption of the UV stabilizer. As described above, the UV stabilizer is added to the multifunctional adhesive film, when the multifunctional adhesive film is exposed to UV, the dye is decomposed from UV, such that the deterioration of the function is prevented, thus improving the durability.

In the case of when the content of the UV stabilizer is less than 0.01 parts by weight, since the UV cutting efficiency is lowered, the discoloration of dye may occur, and in the case of when the content is more than 50 parts by weight, the absorption occurs in the visible ray region, thus affecting an optical characteristic and a change in physical properties of the adhesive agent.

In detail, if the content of the UV stabilizer is too small, since the UV stabilizer does not sufficiently absorb UV, thus affecting the dye. Thus, the dye is decomposed, thus deteriorating the function.

In addition, if the UV stabilizer is added in an excessive amount, the UV stabilizer absorption wavelength region affects the visible ray region, and negatively affects the color of the multifunctional adhesive film, and the UV stabilizer may be precipitated in the multifunctional adhesive film.

As described above, the durability of the multifunctional adhesive film may be varied according to the addition amount of UV stabilizer. The reason is that the content of the UV stabilizer that exists in the same region as the multifunctional adhesive film is varied according to the addition amount of the UV stabilizer, when the UV energies that are exposed to the multifunctional adhesive film are the same as each other, according to whether the energy is sufficiently absorbed or not, the amount of energy that can affect the dye may be large or small.

The UV stabilizer disperses electronic energy that is excited by the UV absorption into heat energy and stabilizes it, and terminates free radicals, thus protecting the multifunctional adhesive from UV. However, since the intrinsic UV absorption function may be deteriorated, it may be used in conjunction with the radical scabenger (HALS) that stops a photooxidation reaction by removing the free radicals and has a function of decomposing peroxides.

The adhesive force of the multifunctional adhesive film according to the present invention is in the range of 2 N/25 mm to 35 N/25 mm at a stripping angle of 180-degree and a stripping rate of 300 mm/min, and preferably in the range of 3 N/25 mm to 20 N/25 mm at a stripping angle of 180-degree and a stripping rate of 300 mm/min.

In the case of when the adhesive force is less than 2 N/25 mm at a stripping angle of 180-degree and a stripping rate of 300 mm/min, since bubbles are formed between the layers or stripping occurs in terms of the durability, the durability may be deteriorated.

In the case of when the multifunctional adhesive film according to the present invention includes the color correction dye and the UV stabilizer, the average penetration ratio of the near IR region (850 to 1000 nm) of the multifunctional adhesive film may be 80 to 100%.

In the case of when the multifunctional adhesive film according to the present invention includes the color correction dye and the UV stabilizer, the average penetration ratio of the visible ray region (380 to 780 nm) of the multifunctional adhesive film may be 60 to 85%.

In the case of when the multifunctional adhesive film according to the present invention includes the color correction dye and the UV stabilizer, the average penetration ratio of the UV region (250 to 380 nm) of the multifunctional adhesive film may be 0 to 70%. It is preferable that the penetration ratio is 70% or less in the UV region (380 nm).

In the case of when the multifunctional adhesive film according to the present invention includes the color correction dye and the UV stabilizer, the average penetration ratio of the near IR region (850 to 1000 nm) of the multifunctional adhesive film may be 0 to 30%.

In the case of when the multifunctional adhesive film according to the present invention includes the near IR absorption dye, color correction dye and UV stabilizer, the average penetration ratio of the visible ray region (380 to 780 nm) of the multifunctional adhesive film may be 40 to 70%.

In the case of when the multifunctional adhesive film according to the present invention includes the color correction dye and the UV stabilizer, the average penetration ratio of the UV region (250 to 380 nm) of the multifunctional adhesive film may be 0 to 40%. It is preferable that the penetration ratio is 35% or less in the UV region (380 nm).

The method for multifunctional adhesive film according to the present invention is not particularly limited. After the coating solution at least one of the near IR absorption dye and color correction dye and the UV stabilizer is manufactured, the multifunctional adhesive film may be manufactured by coating and drying the coating solution on at least one side of the flat glass or transparentization substrate by using various methods. The exposed surface may be covered with a stripping sheet. In addition, the multifunctional adhesive film may be obtained by coating and drying it on the stripping surface of the stripping sheet.

In detail, it may be manufactured by mixing at least one of the near IR absorption dye and color correction dye, UV stabilizer and binder with each other, adding a predetermined amount of crosslinking agent and coupling agent thereto, manufacturing the coating solution, and coating and curing them on the glass or transparentization substrate. It is preferable that the thickness of the thickness of the obtained multifunctional adhesive film is in the range of 5 to 30 μm. In the case of when the thickness of the multifunctional adhesive film deviates from the above range, an adhesive property of the multifunctional adhesive film may be deteriorated.

As the coating method, various methods such as spray coating, roll coating, bar coating, spin coating, gravure coating, blade coating and the like may be used.

One or more other functional films may be further provided on at least one side of the multifunctional adhesive film that is stripped from the multifunctional adhesive film or stripping sheet that is layered on at least one side of glass or transparentization substrate. In addition, after at least one of functional films are layered on at least one side of the glass or transparentization substrate, the multifunctional adhesive film according to the present invention may be provided on at least one side of the glass or transparentization substrate on which one or more functional films are layered or provided between the one or more functional films that are layered on at least one side of the glass or transparentization substrate, but is not limited thereto.

The functional film is a mesh-shaped electromagnetic wave shielding film, transparentization conductive layer electromagnetic wave shielding film, anti-reflection film, near IR absorption film, color correction film, impact reducing film or contrast ratio improving film.

The transparentization substrate may be used without a limitation of material as long as it is a material that has excellent optical transparency. For example, it may be manufactured by using at least one that is selected from polyacryls, polyurethanes, polyesters, polyepoxys, polyolefines, polycarbonates, celluloses and glass, and it is preferable that it is provided by using a transparentization PET (poly ethylene terephthalate).

In addition, the multifunctional adhesive film according to the present invention may be applied as the transparentization layer of the electromagnetic wave shielding film having the mesh shape. Therefore, the present invention provides an electromagnetic wave shielding film and an electromagnetic wave shielding film that includes the multifunctional adhesive film according to the present invention that is provided as the transparentization layer on the electromagnetic wave shielding film.

The transparentization means that slight cloudiness of the image that is not clear by scattering of light by fine air layer is converted into transparency of the fine air layer by filling the transparent resin in the fine air layer.

In the electromagnetic wave shielding film according to the present invention, in the configuration of the transparentization substrate and the conductive pattern portion having the mesh shape that is provided on the transparentization substrate, is formed of any one of copper, silver, gold, iron, nickel, alumina and an alloy thereof, and has a protruding portion and a groove portion, an adhesive transparentization layer may be formed on the upper portion of the electromagnetic wave shielding film through the steps for coating the coating solution that includes at least one of the near IR absorption dye and color correction dye according to the present invention and the UV stabilizer on the upper portion of the electromagnetic wave shielding film so that the upper region of the conductive pattern portion is made flat by filling the groove portion of the conductive pattern portion and transparentizing it.

In the case of when the multifunctional adhesive film is used as the transparentization layer, it is preferable that the thickness of the transparentization layer is 5 to 30 μm on the basis of the protruding surface of the conductive pattern portion.

On the basis of the protruding surface, in the case of when the thickness of the multifunctional adhesive film is less than 5 μm, the transparentization function cannot be performed, and in the case of when the content is more than 30 μm, an adhesive property may be deteriorated.

If the transparentization layer is formed, since the internal space of the groove portion becomes transparent by filling the transparent resin in the groove portion of the conductive pattern portion, the problem of the image that is not clear and slight cloudy caused by scattering of light by air in the groove portion is solved, such that a clear image can be provided. The step for, after coating the coating solution that includes at least one of the near IR absorption dye and color correction dye and the UV stabilizer, transparentizing it may be performed by applying an appropriate pressure thereto. The degree of pressure may be selected by those who are skilled in the art according to the kind of adhesive agent, the use amount and other process condition.

In addition, the present invention provides a plasma display panel filter that includes a multifunctional adhesive film.

A known plasma display panel filter is limited in views of structure because the UV film is disposed only in front of the film that has a specific function, but the plasma display panel filter according to the present invention, in the case of when the multifunctional adhesive film is layered on the glass, transparentization substrate or other functional film, may be disposed at any position without a limitation of the position, thus being manufactured freely in views of structure.

In detail, the plasma display panel filter according to the present invention may further include one or more other functional films on at least one side of the glass and transparentization substrate on which the multifunctional adhesive film is layered after the multifunctional adhesive film according to the present invention is layered on the glass and transparentization substrate. In addition, after at least one of functional films are layered on at least one side of the glass or transparentization substrate, the multifunctional adhesive film according to the present invention may be provided on at least one side of the glass or transparentization substrate on which one or more functional films are layered or provided between the one or more functional films that are layered on at least one side of the glass or transparentization substrate, but is not limited thereto.

The functional film is a mesh-shaped electromagnetic wave shielding film, transparent conductive layer electromagnetic wave sheltering, anti-reflection film, near IR absorption film, color correction film, impact reducing film or contrast ratio improving film.

In addition, the present invention provides a plasma display that includes the plasma display panel filter.

The plasma display panel according to the present invention may have the configuration that is well known in the art, except that it includes the plasma display panel filter according to the present invention.

### MODE FOR INVENTION

Hereinafter, the present invention is illustrated through Examples, but the scope of the present invention is not limited by them.

### Example 1

70 g of the butylatrylate (BA)/hydroxy ethylmethacrylate (HEMA) copolymer solution that was dissolved in ethylacetate, 0.35 g of the UV stabilizer that was represented by the following Formula 12a, 0.015 g of the neon-cut dye porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

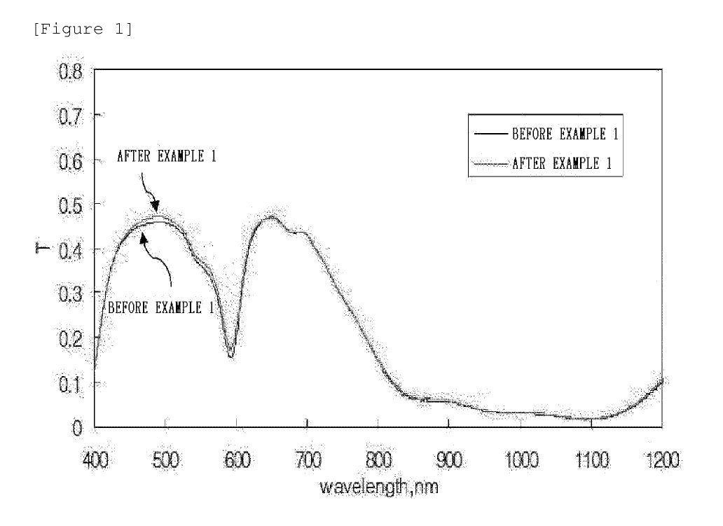

After the manufactured film was coated on the near IR shielding film to manufacture the filter, the penetration ratio was measured before and after it was left to the UV-A light source at 60° C. for 100 hours, and the results are shown in FIG. 1. As the evaluation result before and after the UV test of the filter that included the multifunctional adhesive layer according to the present invention, the change of the penetration ratio in the visible ray region was 550 nm 1.2%, 590 nm 2.1%, and the change of the near IR penetration ratio was 850 nm 0.3%, and 950 nm 0.2%.

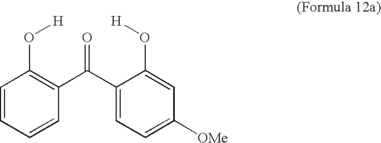

### Example 2

70 g of the butylacrylate (BA)/hydroxy acrylic acid (AA) that was dissolved in ethylacetate, 0.35 g of the UV stabilizer that was represented by the following Formula 13a, 0.015 g of the neon-cut dye porphyrine-based PD319 (Mitsui), 0.137 g of the isocyanate-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

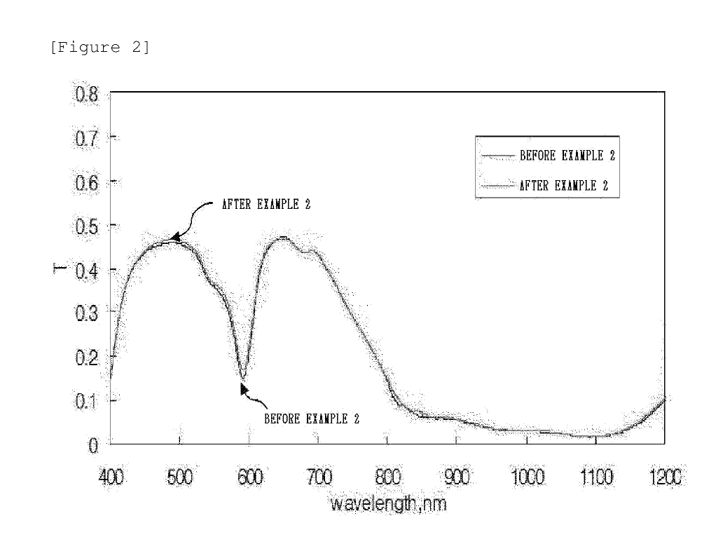

After the manufactured film was coated on the near IR shielding film to manufacture the filter, the penetration ratio was measured before and after it was left to the UV-A light source at 60° C. for 100 hours, and the results are shown in FIG. 2. As the evaluation result before and after the UV test of the filter that included the multifunctional adhesive layer according to the present invention, the change of the penetration ratio in the visible ray region was 550 nm 0.9%, 590 nm 1.8%, and the change of the near IR penetration ratio was 850 nm 0.9%, and 950 nm 0.0%.

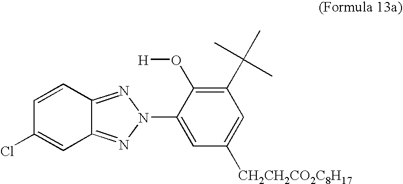

### Example 3

70 g of the butylacrylate (BA)/acrylic acid (AA) that was dissolved in ethylacetate, 0.35 g of the UV stabilizer that was represented by Formula 13a, 0.2 g of the UV stabilizer that was represented by the following Formula 14a, 0.015 g of the neon-cut dye porphyrine-based PD319 (Mitsui), 0.137 g of the isocyanate-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

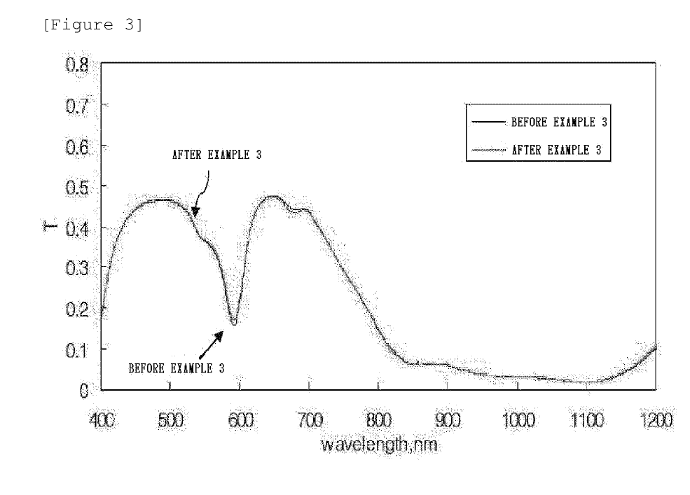

After the manufactured film was coated on the near IR shielding film to manufacture the filter, the penetration ratio was measured before and after it was left to the UV-A light source at 60° C. for 100 hours, and the results are shown in FIG. 3. As the evaluation result before and after the UV test of the filter that included the multifunctional adhesive layer according to the present invention, the change of the penetration ratio in the visible ray region was 550 nm 0.2%, 590 nm 1.5%, and the change of the near IR penetration ratio was 850 nm 0.3%, and 950 nm 0.2%.

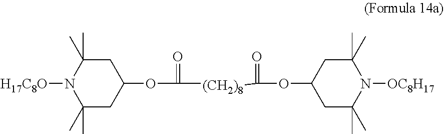

### Example 4

70 g of the butylacrylate (BA)/acrylic acid (AA) that was dissolved in ethylacetate, 0.35 g of the UV stabilizer that was represented by Formula 12a, 0.06 g of the near IR dye metal complex (metal-complex)-based NKX1199 (Hayashibara), 0.14 g of the phthalocyanine-based 910B (Japan catalyst), 0.008 g of the neon-cut dye porphyrine-based PD319 (Mitsui), 0.137 g of the isocyanate-based crosslinking agent, 0.035 g of the epoxy-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

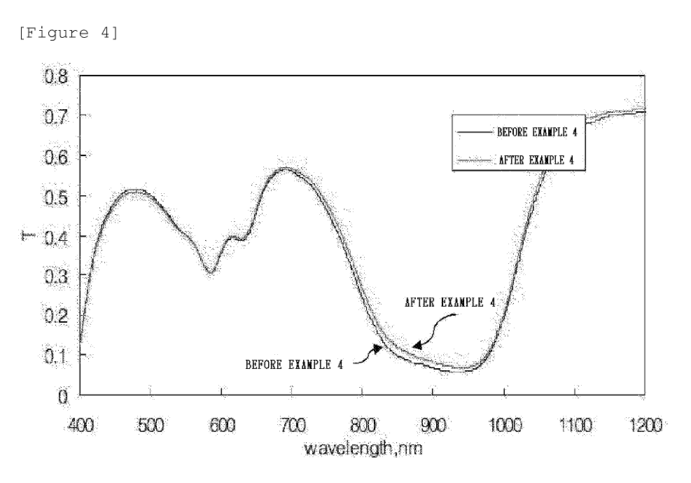

After the filter was manufactured by using the manufactured film, the penetration ratio before and after it was left to the UV-A light source at 60° C. for 100 hours was measured, and the result thereof is shown in FIG. 4. As the evaluation result before and after the UV test of the filter that included the multifunctional adhesive layer according to the present invention, the change of the penetration ratio in the visible ray region was 550 nm 0.2%, 590 nm 0.1%, and the change of the near IR penetration ratio was 850 nm 2.2%, and 950 nm 1.0%.

### Example 5

70 g of the butylacrylate (BA)/acrylic acid (AA) that was dissolved in ethylacetate, 0.35 g of the UV stabilizer that was represented by Formula 13a, 0.06 g of the near IR dye metal complex (metal-complex)-based NKX1199 (Hayashibara), 0.14 g of the phthalocyanine-based 910B (Japan catalyst), 0.015 g of the neon-cut dye porphyrine-based PD319 (Mitsui), 0.137 g of the isocyanate-based crosslinking agent, 0.035 g of the epoxy-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

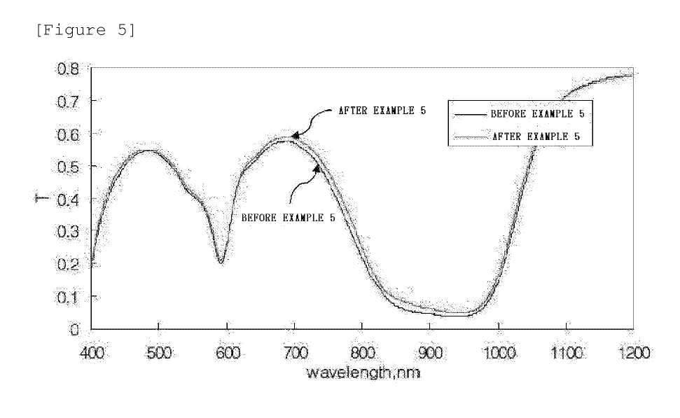

After the filter was manufactured by using the manufactured film, the penetration ratio before and after it was left to the UV-A light source at 60° C. for 100 hours was measured, and the result thereof is shown in FIG. 5. As the evaluation result before and after the UV test of the filter that included the multifunctional adhesive layer according to the present invention, the change of the penetration ratio in the visible ray region was 550 nm 1.0%, 590 nm 1.2%, and the change of the near IR penetration ratio was 850 nm 2.2%, and 950 nm 1.1%.

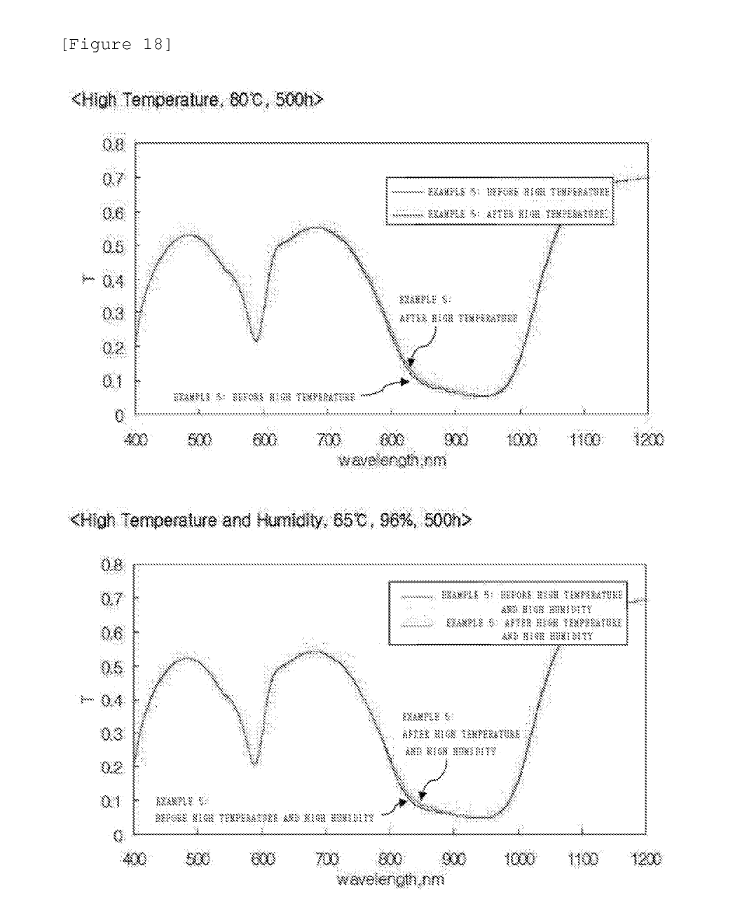

After it was stored by using the same filter under the condition of high temperature (80° C.) and high temperature and humidity (65° C., relative humidity 96%) for 500 hours, the penetration ratio was measured, and the result thereof is shown in FIG. 18. As the evaluation result before and after the durability test of the filter that included the multifunctional adhesive layer according to the present invention, the change of the penetration ratio in the visible ray region was 550 nm 0.3%, 590 nm 0.2%, and the change of the near IR penetration ratio was 850 nm 0.8%, and 950 nm 0.3%, and after the storage at high temperature and high humidity, the change of the penetration ratio of the visible ray region was 550 nm 0.2% and 590 nm 0.2%, and the change of the near IR penetration ratio was 850 nm 0.9% and 950 nm 0.4%.

### Example 6

70 g of the butylacrylate (BA)/acrylic acid (AA) that was dissolved in ethylacetate, 0.35 g of the UV stabilizer that was represented by Formula 13a, 0.2 g of the UV stabilizer that was represented by Formula 14a, 0.06 g of the near IR dye metal complex (metal-complex)-based NKX1199 (Hayashibara), 0.14 g of the phthalocyanine-based 910B (Japan catalyst), 0.015 g of the neon-cut dye porphyrine-based PD319 (Mitsui), 0.137 g of the isocyanate-based crosslinking agent, 0.035 g of the epoxy-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

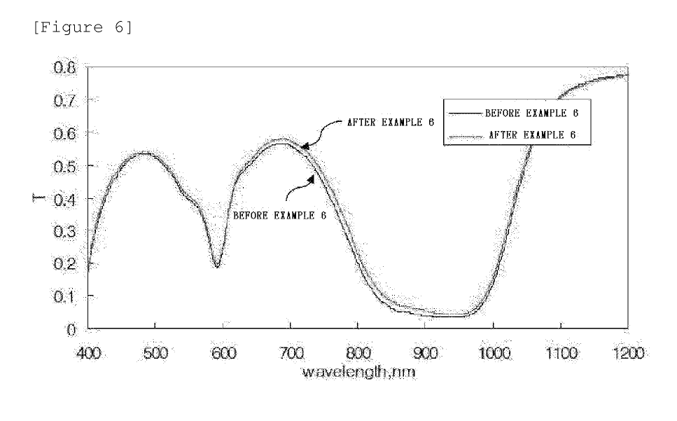

After the filter was manufactured by using the manufactured film, the penetration ratio before and after it was left to the UV-A light source at 60° C. for 100 hours was measured, and the result thereof is shown in FIG. 6. As the evaluation result before and after the UV test of the filter that included the multifunctional adhesive layer according to the present invention, the change of the penetration ratio in the visible ray region was 550 nm 1.1%, 590 nm 1.2%, and the change of the near IR penetration ratio was 850 nm 2.0%, and 950 nm 0.6%.

### Example 7

70 g of the butylatrylate (BA)/hydroxy ethylmethacrylate (HEMA) copolymer solution that was dissolved in ethylacetate, 1 g of the UV stabilizer that was represented by the following Formula 12a, 0.08 g of the phthalocyanine-based 910B (Japan Catalyst), 0.05 g of 906B (Japan Catalyst), 0.05 g of IR10A (Japan Catalyst), 0.015 g of the neon-cut dye porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

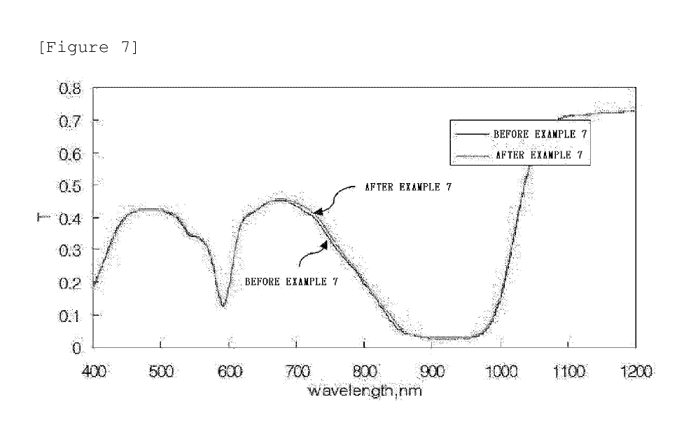

After the filter was manufactured by using the manufactured film, the penetration ratio before and after it was left to the UV-A light source at 60° C. for 100 hours was measured, and the result thereof is shown in FIG. 7. As the evaluation result before and after the UV test of the filter that included the multifunctional adhesive layer according to the present invention, the change of the penetration ratio in the visible ray region was 550 nm 0.4%, 590 nm 0.5%, and the change of the near IR penetration ratio was 850 nm 1.4% and 950 nm 0.2%.

### Example 8

70 g of the butylatrylate (BA)/hydroxy ethylmethacrylate (HEMA) copolymer solution that was dissolved in ethylacetate, 1 g of the UV stabilizer that was represented by the following Formula 13a, 0.08 g of the phthalocyanine-based 910B (Japan Catalyst), 0.05 g of 906B (Japan Catalyst), 0.05 g of IR10A (Japan Catalyst), 0.015 g of the neon-cut dye porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

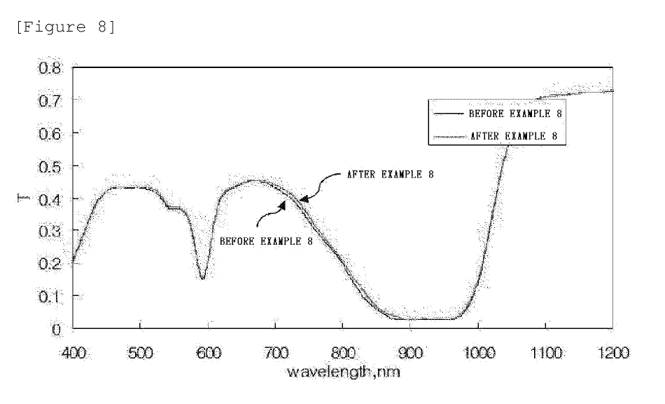

After the filter was manufactured by using the manufactured film, the penetration ratio before and after it was left to the UV-A light source at 60° C. for 100 hours was measured, and the result thereof is shown in FIG. 8. As the evaluation result before and after the UV test of the filter that included the multifunctional adhesive layer according to the present invention, the change of the penetration ratio in the visible ray region was 550 nm 0.5%, 590 nm 0.6%, and the change of the near IR penetration ratio was 850 nm 0.8%, and 950 nm 0.0%.

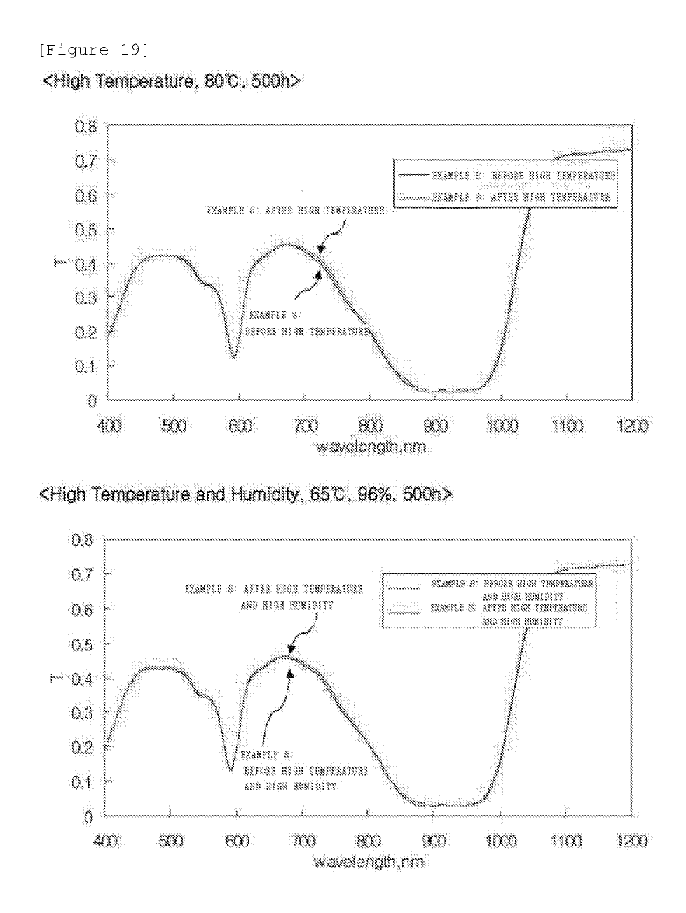

After it was stored by using the same filter under the condition of high temperature (80° C.) and high temperature and humidity (65° C., relative humidity 96%) for 500 hours, the penetration ratio was measured, and the result thereof is shown in FIG. 19. As the evaluation result before and after the durability test of the filter that included the multifunctional adhesive layer according to the present invention, the change of the penetration ratio in the visible ray region was 550 nm 0.5%, 590 nm 0.4%, and the change of the near IR penetration ratio was 850 nm 1.1%, and 950 nm 0.1%, and after the storage at high temperature and high humidity, the change of the penetration ratio of the visible ray region was 550 nm 0.7% and 590 nm 0.4%, and the change of the near IR penetration ratio was 850 nm 0.6% and 950 nm 0.1%.

### Example 9

70 g of the butylacrylate (BA)/acrylic acid (AA) that was dissolved in ethylacetate, 0.35 g of the UV stabilizer that was represented by Formula 12a, 0.06 g of the near IR absorption dye metal complex (metal-complex)-based NKX1199 (Hayashibara), 0.10 g of the near IR absorption dye metal complex (metal-complex)-based APE-004 (API), 0.008 g of the neon-cut dye porphyrine-based PD319 (Mitsui), 0.137 g of the isocyanate-based crosslinking agent, 0.035 g of the epoxy-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

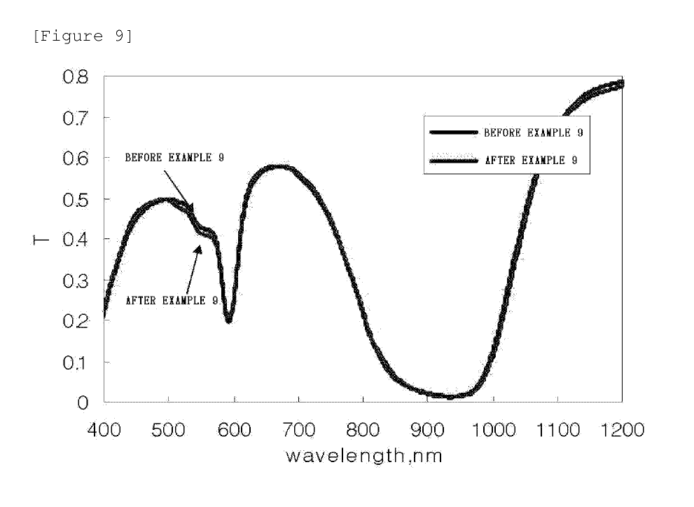

After the filter was manufactured by using the manufactured film, the penetration ratio before and after it was left to the UV-A light source at 60° C. for 100 hours was measured, and the result thereof is shown in FIG. 9. As the evaluation result before and after the UV test of the filter that included the multifunctional adhesive layer according to the present invention, the change of the penetration ratio in the visible ray region was 550 nm 1.4%, 590 nm 0.7%, and the change of the near IR penetration ratio was 850 nm 1.7%, and 950 nm 1.6%.

### Comparative Example 1

70 g of the butylatrylate (BA)/hydroxy ethylmethacrylate (HEMA) copolymer solution that was dissolved in ethylacetate, 0.015 g of the neon-cut porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

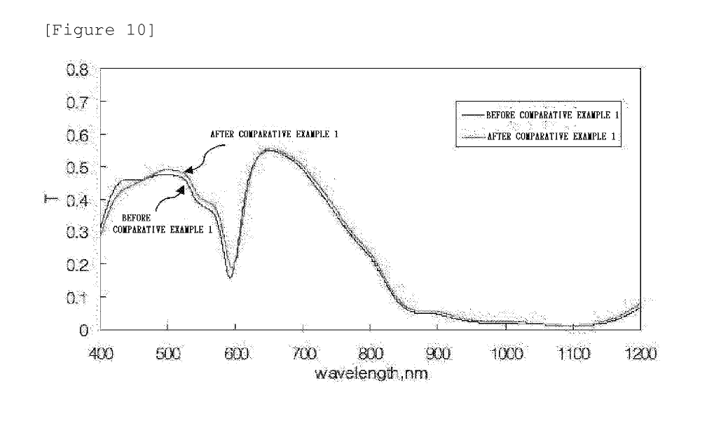

After the manufactured film was coated on the near IR shielding film to manufacture the filter, the penetration ratio was measured after it was left to the UV-A light source at 60° C. for 100 hours, and the results are shown in FIG. 10. As the evaluation result before and after the UV test of the filter that included the multifunctional adhesive layer according to the present invention, the change of the penetration ratio in the visible ray region was 550 nm 2.1%, 590 nm 4.9%, and the change of the near IR penetration ratio was 850 nm 0.5%, and 950 nm 0.8%.

### Comparative Example 2

70 g of the butylatrylate (BA)/hydroxy ethylmethacrylate (HEMA) copolymer solution that was dissolved in ethylacetate, 0.05 g of the UV stabilizer that was represented by the following Formula 15, 0.015 g of the neon-cut dye porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

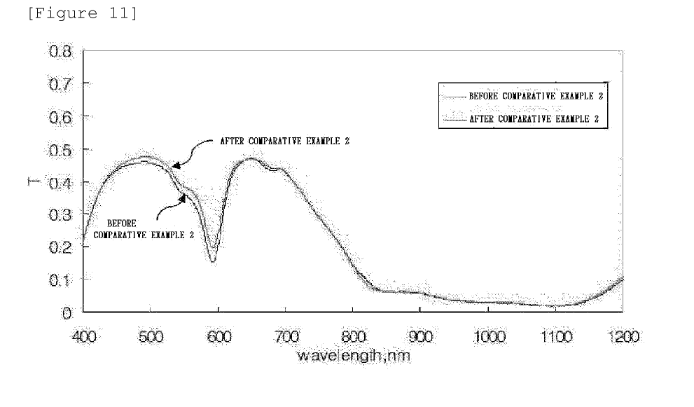

After the manufactured film was coated on the near IR shielding film to manufacture the filter, the penetration ratio was measured after it was left to the UV-A light source at 60° C. for 100 hours, and the results are shown in FIG. 11. As the evaluation result before and after the UV test of the filter that included the multifunctional adhesive layer according to the present invention, the change of the penetration ratio in the visible ray region was 550 nm 2.4%, 590 nm 4.5%, and the change of the near IR penetration ratio was 850 nm 0.3% and 950 nm 0.3%.

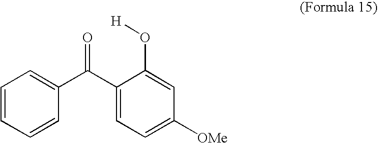

### Comparative Example 3

70 g of the butylatrylate (BA)/hydroxy ethylmethacrylate (HEMA) copolymer solution that was dissolved in ethylacetate, 0.05 g of the UV stabilizer that was represented by the following Formula 16, 0.015 g of the neon-cut dye porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

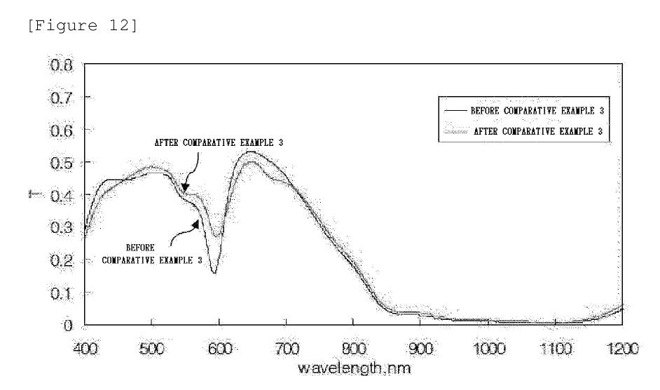

After the manufactured film was coated on the near IR shielding film to manufacture the filter, the penetration ratio was measured after it was left to the UV-A light source at 60° C. for 100 hours, and the results are shown in FIG. 12. As the evaluation result before and after the UV test of the filter that included the multifunctional adhesive layer according to the present invention, the change of the penetration ratio in the visible ray region was 550 nm 2.0%, 590 nm 12.4%, and the change of the near IR penetration ratio was 850 nm 0.8%, and 950 nm 0.5%.

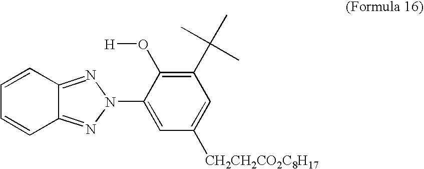

### Comparative Example 4

70 g of the butylatrylate (BA)/hydroxy ethylmethacrylate (HEMA) copolymer solution that was dissolved in ethylacetate, 0.5 g of the UV stabilizer that was represented by Formula 14a, 0.015 g of the neon-cut dye porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

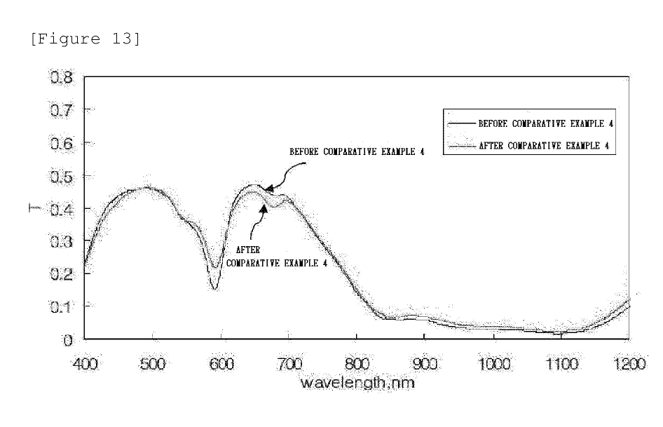

After the manufactured film was coated on the near IR shielding film to manufacture the filter, the penetration ratio was measured after it was left to the UV-A light source at 60° C. for 100 hours, and the results are shown in FIG. 13. As the evaluation result before and after the UV test of the filter that included the multifunctional adhesive layer according to the present invention, the change of the penetration ratio in the visible ray region was 550 nm 0.4%, 590 nm 6.8%, and the change of the near IR penetration ratio was 850 nm 0.6% and 950 nm 0.9%.

### Comparative Example 5

70 g of the butylacrylate (BA)/acrylic acid (AA) that was dissolved in ethylacetate, 0.06 g of the near IR dye metal complex (metal-complex)-based NKX1199 (Hayashibara), 0.14 g of the phthalocyanine-based 910B (Japan catalyst), 0.015 g of the neon-cut dye porphyrine-based PD319 (Mitsui), 0.137 g of the isocyanate-based crosslinking agent, 0.035 g of the epoxy-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

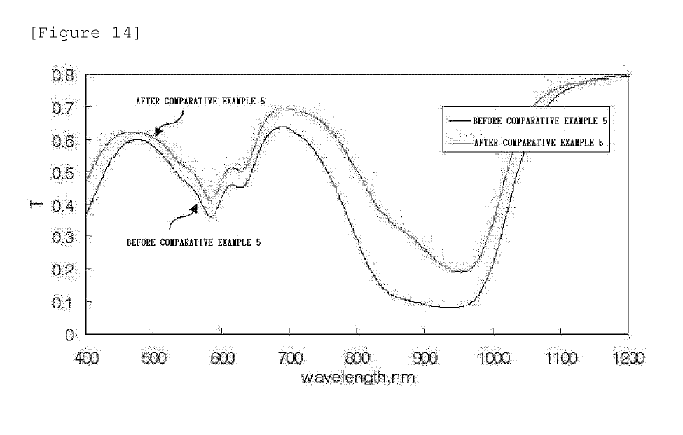

After the filter was manufactured by using the manufactured film, the penetration ratio before and after it was left to the UV-A light source at 60° C. for 100 hours was measured, and the result thereof is shown in FIG. 14. As the evaluation result before and after the UV test of the filter that included the multifunctional adhesive layer according to the present invention, the change of the penetration ratio in the visible ray region was 550 nm 4.7%, 590 nm 5.1%, and the change of the near IR penetration ratio was 850 nm 22.3% and 950 nm 10.9%.

### Comparative Example 6

70 g of the butylacrylate (BA)/acrylic acid (AA) that was dissolved in ethylacetate, 1 g of the UV stabilizer that was represented by Formula 15, 0.06 g of the near IR dye metal complex (metal-complex)-based NKX1199 (Hayashibara), 0.14 g of the phthalocyanine-based 910B (Japan catalyst), 0.015 g of the neon-cut dye porphyrine-based PD319 (Mitsui), 0.137 g of the isocyanate-based crosslinking agent, 0.035 g of the epoxy-based crosslinking agent and 0.021 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

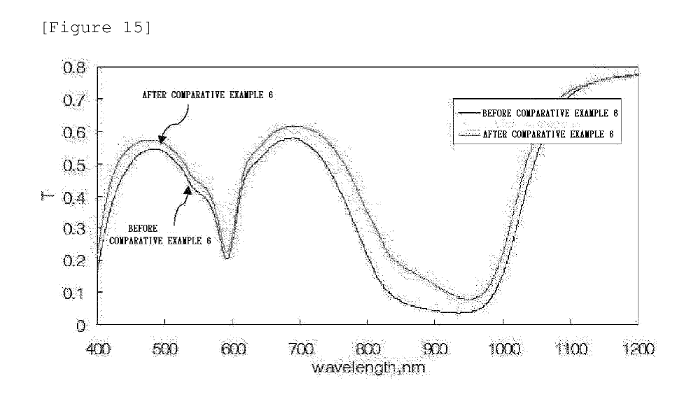

After the filter was manufactured by using the manufactured film, the penetration ratio before and after it was left to the UV-A light source at 60° C. for 100 hours was measured, and the result thereof is shown in FIG. 15. As the evaluation result before and after the UV test of the filter that included the multifunctional adhesive layer according to the present invention, the change of the penetration ratio in the visible ray region was 550 nm 2.4%, 590 nm 3.1%, and the change of the near IR penetration ratio was 850 nm 11.3% and 950 nm 3.9%.

### Comparative Example 7

70 g of the butylatrylate (BA)/hydroxy ethylmethacrylate (HEMA) copolymer solution that was dissolved in ethylacetate, 1 g of the UV stabilizer that was represented by the following Formula 16, 0.08 g of the phthalocyanine-based 910B (Japan Catalyst), 0.05 g of 906B (Japan Catalyst), 0.05 g of IR10A (Japan Catalyst), 0.015 g of the neon-cut dye porphyrine-based PD319 (Mitsui), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

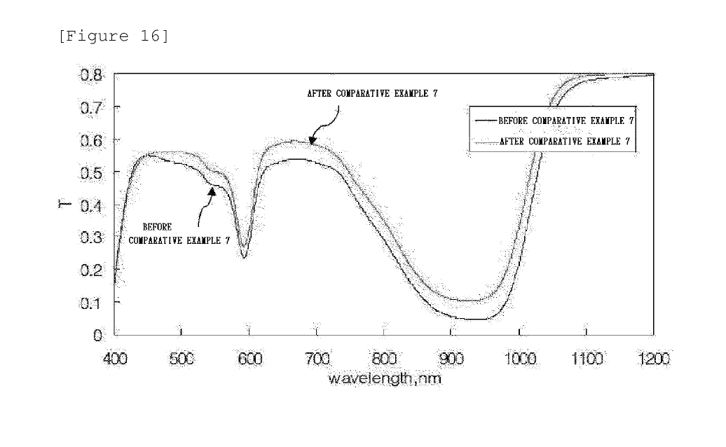

After the filter was manufactured by using the manufactured film, the penetration ratio before and after it was left to the UV-A light source at 60° C. for 100 hours was measured, and the result thereof is shown in FIG. 16. As the evaluation result before and after the UV test of the filter that included the multifunctional adhesive layer according to the present invention, the change of the penetration ratio in the visible ray region was 550 nm 4.2%, 590 nm 3.3%, and the change of the near IR penetration ratio was 850 nm 5.0% and 950 nm 6.3%.

### Comparative Example 8

70 g of the butylatrylate (BA)/hydroxy ethylmethacrylate (HEMA) copolymer solution that was dissolved in ethylacetate, 0.35 g of the UV stabilizer that was represented by Formula 12a, 0.030 g of the neon-cut dye squarylium-based HAO1 (Hayashibara), 0.037 g of the isocyanate-based crosslinking agent and 0.048 g of the silane-based coupling agent were added to 30 g of methylethylketone (MEK), and mixed with each other to manufacture the coating solution.

The coating solution was coated on the release substrate film in a thickness of 25 μm, and dried at 120° C. for 3 min, and the other side was laminated with the release substrate to manufacture the multifunctional adhesive film.

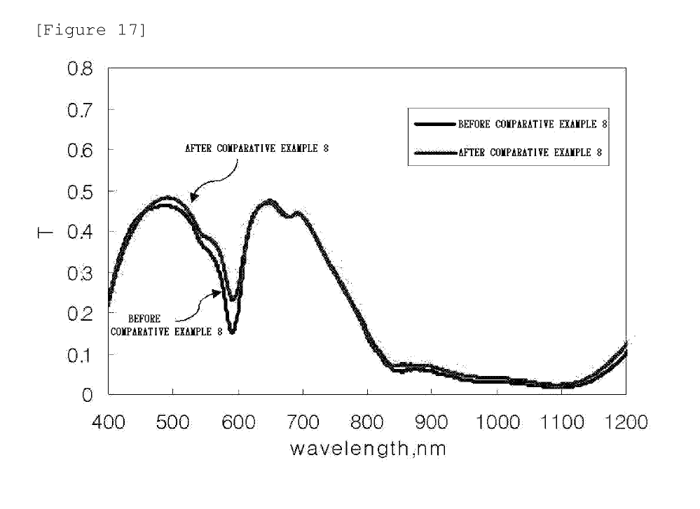

After the manufactured film was coated on the near IR shielding film to manufacture the filter, the penetration ratio was measured before and after it was left to the UV-A light source at 60° C. for 100 hours, and the results are shown in FIG. 17. As the evaluation result before and after the UV test of the filter that included the multifunctional adhesive layer according to the present invention, the change of the penetration ratio in the visible ray region was 550 nm 3.4% and 590 nm 8.5%, and the change of the near IR penetration ratio was 850 nm 1.5% and 950 nm 1.0%.

As shown in the evaluation result before and after the UV test of FIGS. 1 to 19, in the case of Examples 1 to 9, if the penetration spectrums before and after the UV test are compared to each other, since there is almost no change before and after the test, that is, almost no change in penetration spectrum, it can be confirmed that the durability is excellent without a reduction of the function that is caused by a change of physical properties in the UV test. However, in the case of Comparative Examples 1 to 8, if the penetration spectrums before and after the UV test are compared to each other, it can be seen that a change before and after the test, that is, a change of penetration spectrum, is large. Therefore, it can be confirmed that the durability is lower in Comparative Examples 1 to 8 than in Examples 1 to 9.

1. A multifunctional adhesive film comprising:
at least one of near IR absorption dye and color correction dye; and
a UV stabilizer.

2.-4. (canceled)

5. The multifunctional adhesive film as set forth in claim 1, wherein a component for providing an adhesive property to the multifunctional adhesive film is a pressure reduction adhesive agent.

6.-10. (canceled)

11. The multifunctional adhesive film as set forth in claim 1, wherein the near IR absorption dye is one or more dyes that are selected from the group consisting of a metal complex-based dye, phthalocyanine-based dye, naphthalocyanine-based dye, cyanine-based dye having an intermolecular metal-complex shape and diimonium-based dye.

12.-17. (canceled)

18. The multifunctional adhesive film as set forth in claim 1, wherein the color correction dye is a neon-cut dye.

19. The multifunctional adhesive film as set forth in claim 18, wherein the color correction dye is one or more dyes that are selected from the group consisting of a porphyrine-based dye having an intramolecular metal-complex shape, a cyanine-based dye having an intermolecular metal-complex shape and a squarylium-based dye having an intermolecular metal-complex shape.

20.-21. (canceled)

22. The multifunctional adhesive film as set forth in claim 1, wherein the UV stabilizer is one or more that are selected from the group consisting of a benzophonone-based absorption agent and benzotriazole-based absorption agent.

23. The multifunctional adhesive film as set forth in claim 22, wherein the UV stabilizer further includes a radical scabenger (HALS) compound.

24. The multifunctional adhesive film as set forth in claim 22, wherein the benzophonone-based absorption agent is represented by the following Formula 12: 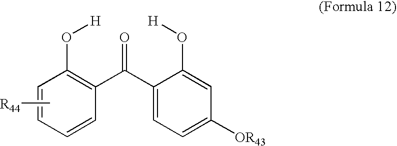
wherein
R₄₃ and R₄₄ are the same as or different from each other, and independently, a hydrogen atom; halogen atom; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; or a C_{6˜20} aryloxy group where a halogen atom, cyano group, or nitro group is substituted or unsubstituted.

25. The multifunctional adhesive film as set forth in claim 22, wherein the benzotriazole-based absorption agent is represented by the following Formula 13: 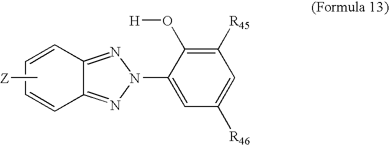
wherein
Z is a chlorine substituent,
R₄₅ and R₄₆ are the same as or different from each other, and independently, a hydrogen atom; halogen atom; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; or a C_{6˜20} aryloxy group where a halogen atom, cyano group, or nitro group is substituted or unsubstituted.

26. The multifunctional adhesive film as set forth in claim 23, wherein the radical scabenger (HALS) compound is represented by the following Formula 14: 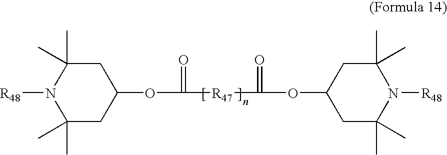
wherein
R₄₇ is CH₃,
n is in the range of 1 to 16,
R₄₈ is a hydrogen atom; a C_{1˜16} alkyl group where a halogen atom, cyano group, or nitro group is substituted or unsubstituted; a C_{6˜20} aryl group where a halogen atom, cyano group, or nitro group is substituted or unsubstituted; a C_{1˜16} alkoxy group where a halogen atom, cyano group, or nitro group is substituted or unsubstituted; a C_{6˜20} aryloxy group where a halogen atom, cyano group, or nitro group is substituted or unsubstituted.

27. (canceled)

28. The multifunctional adhesive film as set forth in claim 1, wherein the multifunctional adhesive film includes the color correction dye and the UV stabilizer, and a near IR region average penetration ratio is 80 to 100%.

29. The multifunctional adhesive film as set forth in claim 1, wherein the multifunctional adhesive film includes the color correction dye and the UV stabilizer, and a visible ray region average penetration ratio is 60 to 85%.

30. The multifunctional adhesive film as set forth in claim 1, wherein the multifunctional adhesive film includes the color correction dye and the UV stabilizer, and a UV region average penetration ratio is 0 to 70%.

31. The multifunctional adhesive film as set forth in claim 1, wherein the multifunctional adhesive film includes the near IR absorption dye, the color correction dye and the UV stabilizer, and a near IR region average penetration ratio is 0 to 30%.

32. The multifunctional adhesive film as set forth in claim 1, wherein the multifunctional adhesive film includes the near IR absorption dye, the color correction dye and the UV stabilizer, and a visible ray region average penetration ratio is 40 to 70%.

33. The multifunctional adhesive film as set forth in claim 1, wherein the multifunctional adhesive film includes the near IR absorption dye, the color correction dye and the UV stabilizer, and a UV region average penetration ratio is 0 to 40%.

34.-35. (canceled)

36. The multifunctional adhesive film as set forth in claim 1, wherein the thickness of the multifunctional adhesive film is 5 to 30 μm.

37. The multifunctional adhesive film as set forth in claim 1, wherein the adhesive force of the multifunctional adhesive film is 2 N/25 mm to 35 N/25 mm at a stripping angle of 180-degree and stripping rate of 300 mm/min.

38. An electromagnetic wave shielding film, comprising:
an electromagnetic wave shielding film; and
the multifunctional adhesive film according to
claim 1 which is provided as a transparentization layer on the electromagnetic wave shielding film.

39. (canceled)

40. A plasma display panel filter comprising the multifunctional adhesive film according to claim 1.

41. (canceled)
